(19) United States
(12) Patent Application Publication
(10) Pub. No.: US 2023/0170747 A1
(43) Pub. Date: Jun. 1, 2023

(54) Electric Machine and Motor Vehicle Drive Unit

(71) Applicant: ZF Friedrichshafen AG, Friedrichshafen (DE)

(72) Inventors: Michael Griesbach, Tettnang (DE); Thorsten Müller, Friedrichshafen (DE)

(21) Appl. No.: 18/011,953

(22) PCT Filed: Jun. 17, 2021
(86) PCT No.: PCT/EP2021/066326

§ 371 Date: Dec. 21, 2022

(30) Foreign Application Priority Data
Jun. 24, 2020 (DE) 10 2020 207 816.5

(51) Int. Cl. H02K 1/12; H02K 5/04; H02K 3/04

(52) U.S. Cl. CPC H02K 1/12; H02K 5/04; H02K 3/04

(57) ABSTRACT

An electric machine (EM) is arranged within a housing (GG). A stator (S) is electrically insulated with respect to the housing (GG). A stator laminated core (SB) is secured at the housing (GG) via multiple screws (SS) aligned in the axial direction. Electrically insulating spacers (SD) are arranged between the stator laminated core (SB) and the housing (GG). At least two centering pins (SC) are provided for centering the stator (S) in the housing (GG).

### CROSS-REFERENCE TO RELATED APPLICATIONS

The present application is related and claims priority to 102020207816.5 filed in the German Patent Office on Jun. 24, 2020 and to PCT/EP2021/066326 filed in the European Patent Office on Jun. 17, 2021, both of which are incorporated by reference in their entirety for all purposes.

### FIELD OF THE INVENTION

The invention relates generally to an electric machine that includes a housing. The invention further relates generally to a drive unit for a motor vehicle that includes an electric machine of this type.

### BACKGROUND

DE 100 40 851 A1 describes an electric machine that includes an insulated machine housing. A yoke of the electric machine is electrically insulated with respect to the housing and coupled to the housing ground or housing mass via an inductance. As a result, interference currents in the housing are reduced. The yoke of the electric machine is secured in the housing via radially aligned screwed connections.

FR 2 115 648 A5 describes a configuration for an electrically driven pump. The electric motor of the pump includes a stator laminated core, which is secured at a housing by screws. Electrically insulating spacers are arranged between the housing and the stator laminated core.

### SUMMARY OF THE INVENTION

Example aspects of the invention is directed to insulation of a stator with respect to a housing.

According to example aspects of the present invention, an electric machine that includes a housing is provided. The electric machine is arranged within the housing and includes a rotationally fixed stator and a rotatably mounted rotor. The stator is electrically insulated with respect to the housing. The stator includes a stator laminated core, at which at least one stator winding is arranged. Multiple winding strands can be arranged at the stator laminated core. The stator laminated core including the at least one winding is secured at the housing via multiple screws aligned in the axial direction. “Axial direction” is understood to be the direction of the axis of rotation of the rotor. Electrically insulating spacers are arranged between the stator laminated core and the housing. Additionally, at least two centering pins are provided. The centering pins are used for centering the stator in the housing.

In other words, an electric machine is provided, which has not only an electrically insulating, axially aligned screwed connection of the stator onto the housing, but also an electrically insulating centering of the stator with respect to the housing. As a result, an air gap between the stator and the rotor that is as uniform as possible can be ensured in the case of a stator that is electrically insulated with respect to the housing.

Preferably, each of the centering pins at one end is arranged in a housing bore and, at the other end, in a centering receptacle of the stator laminated core.

According to a first possible example embodiment, the centering pin is metallic, wherein an electrical insulation between the centering pin and the stator laminated core is formed by the centering receptacle in the stator laminated core. A metallic centering pin that is made, for example, of steel, is less brittle than, for example, a centering pin made of ceramic. A design of this type is therefore particularly advantageous for difficult installation conditions in which a high mechanical load acts upon the centering pins.

Preferably, the electrically insulating centering receptacle is formed by electrically insulating sleeves, for example, ceramic sleeves, which are inserted into one recess each in the stator laminated core. Such sleeves have a high strength and can be designed, in an easy way, having the accuracy necessary for centering.

Alternatively, the centering pins can be made of an electrically insulating material, for example, of ceramic. An electrically insulating example embodiment of the centering receptacle in the stator laminated core can be dispensed with in this case.

At least one of the spacers preferably includes a through-hole, wherein at least one of the centering pins is guided through the through-hole. Due to such a multi-piece design of the spacer and the centering pin, low tolerances with respect to the flatness of the spacer, on the one hand, and with respect to the diameter and the straightness of the centering pin, on the other hand, are easily implemented.

Preferably, at least one of the spacers is held in position by the centering pin. The fit between the through-hole and the centering pin is preferably so precise that a displacement of the spacer on the centering pin is possible only against a resistance. This also enables a secure hold of the spacer during assembly.

According to one alternative example embodiment, at least one of the spacers has been clipped into the housing. For this purpose, the spacer can include shoulders, for example, at two opposite sides, the shoulders interacting with a corresponding receptacle at the housing. As a result, the spacer is securely held at the housing, allowing the housing to be swiveled during assembly. If the spacer has the through-hole, the through-hole is to be selected to be large enough not to cause any torsional stress of the centering pin.

According to another possible example embodiment, at least one of the centering pins is designed as one piece with one of the spacers. The centering pin and the spacer therefore form only one single component. Such a spacer including a centering pin is made of an electrically insulating material, for example, from ceramic. As a result, the number of single parts of the electric machine can be reduced in an easy way, enabling the assembly work to be reduced.

According to one possible example embodiment, at least one of the spacers includes a mounting pin, which interacts with a locating bore in the housing. Due to such a design, the mounting of the spacers at the housing can be simplified.

Preferably, at least one of the spacers is bonded onto the stator laminated core or onto the housing. As a result, it is ensured that the spacers are captively held particularly well, in particular when the stator laminated core or the housing is preassembled at various locations or when these components are swiveled during assembly.

The screws preferably do not contact the spacers. In other words, an air gap is preferably provided between the screws and the spacers. As a result, damage to the spacers is avoided when the stator laminated core is screwed down at the housing. Preferably, each of the screws is guided through a through-hole of the spacers.

The electric machine can be an integral part of a drive unit for a motor vehicle, the electric machine being configured for driving the vehicle. For example, the electric machine can be an integral part of an axle that includes an electric drive. Alternatively, the electric machine can be an integral part of a hybrid module, which is arranged in the motor vehicle drive train between the internal combustion engine and the transmission, or between the transmission and the drive axle. According to another alternative, the electric machine can be an integral part of a transmission in the motor vehicle drive train.

### BRIEF DESCRIPTION OF THE DRAWINGS

Exemplary embodiments of the invention are described in detail with reference to the figures, wherein:

FIG. 1a through FIG. 1d show various configurations of a motor vehicle drive train;

FIG. 2a through FIG. 2c each show a schematic sectioning of a motor vehicle drive unit;

FIG. 3a and FIG. 3b each show a view of a spacer according to a first exemplary embodiment;

FIG. 4a and FIG. 4b each show a view of a spacer according to a second exemplary embodiment;

FIG. 5a and FIG. 5b each show a view of a spacer according to a third exemplary embodiment; and FIG. 6a and FIG. 6b each show a view of a spacer according to a fourth exemplary embodiment.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

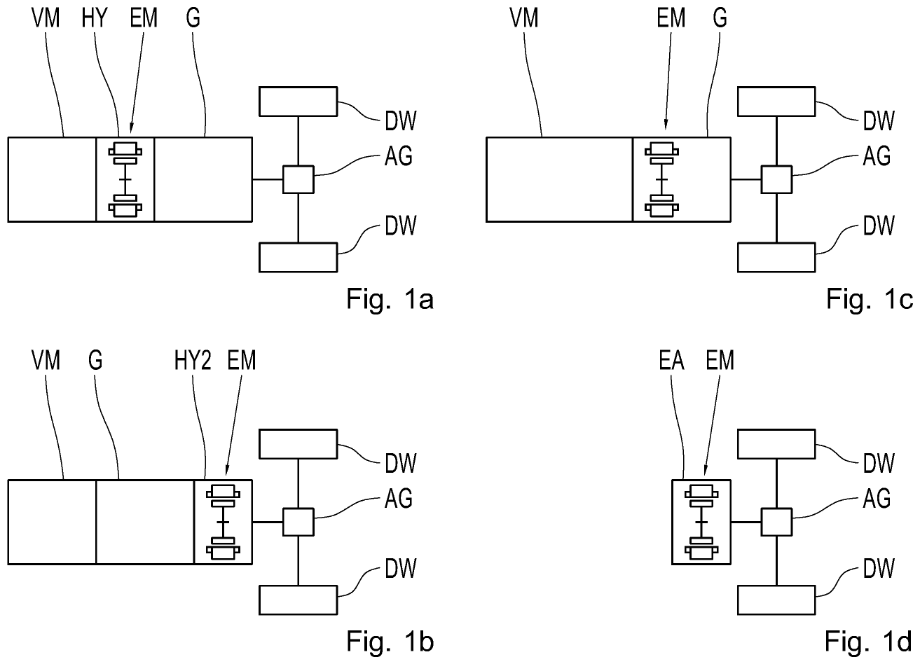

FIG. 1a shows a drive train of a motor vehicle. The drive train includes an internal combustion engine VM. The drive train includes a transmission G for adapting the rotational speed and torque output characteristics of the internal combustion engine VM to the driving resistances of the motor vehicle. The transmission G can be, for example, an automatic transmission, an automated transmission that includes one single launch clutch, a dual-clutch transmission, a CVT transmission, or a manually shifted transmission. The transmission G is connected, at the output end of the transmission G, to a differential gear AG, which distributes the drive power to driving wheels DW.

In the drive train according to FIG. 1a, a hybrid module HY is arranged between the internal combustion engine VM and the transmission G. The hybrid module HY includes an electric machine EM, by which the motor vehicle is drivable purely electrically or in a hybrid manner together with the internal combustion engine VM. The hybrid module HY can include a separating clutch (not shown in FIG. 1a), by which a torque transmission is engageable between the internal combustion engine VM and the electric machine EM.

FIG. 1b shows another configuration of a motor vehicle drive train. A hybrid module HY2 is provided in the motor vehicle drive train, the hybrid module HY2 being arranged at the output side of the transmission G, in contrast to the drive train according to FIG. 1a. The hybrid module HY2 also includes an electric machine EM, by which the motor vehicle is drivable purely electrically or in a hybrid manner together with the internal combustion engine VM.

FIG. 1c shows another configuration of a motor vehicle drive train. A hybrid module is not provided in the motor vehicle drive train. Instead, the electric machine EM is an integral part of the transmission G. A transmission G of this type is also referred to as a hybrid transmission.

FIG. 1d shows another configuration of a motor vehicle drive train, which, in contrast to the drive trains according to FIG. 1a through FIG. 1c, is a purely electric drive train without an internal combustion engine. An electric axle drive EA includes an electric machine EM, the drive power of which is distributed onto driving wheels DW of the motor vehicle via the differential gear AG. A drive train of this type could also include a transmission between the axle drive EA and the differential gear AG, for example, a 2-speed transmission. This type of electric axle drive EA could also be combined with a second axle that is driven by an internal combustion engine.

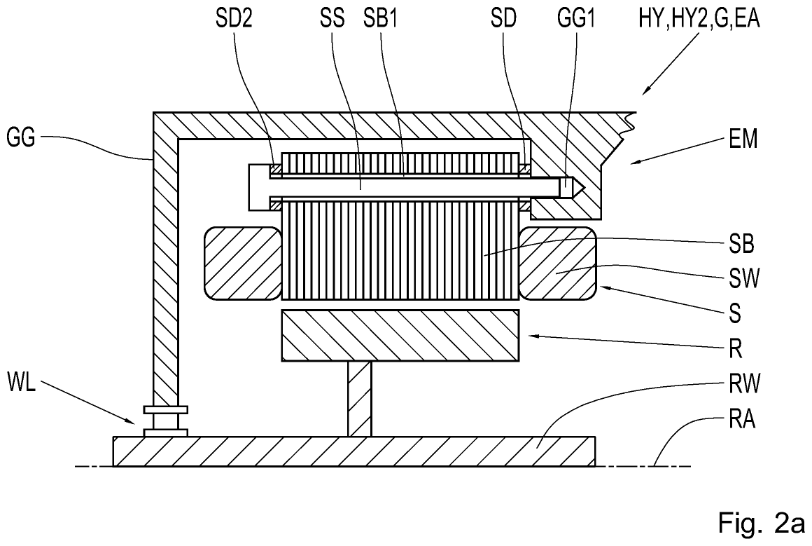

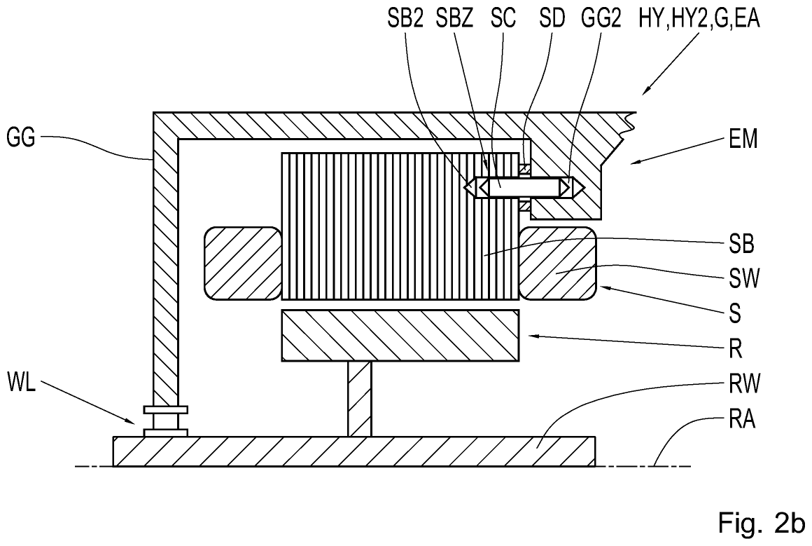

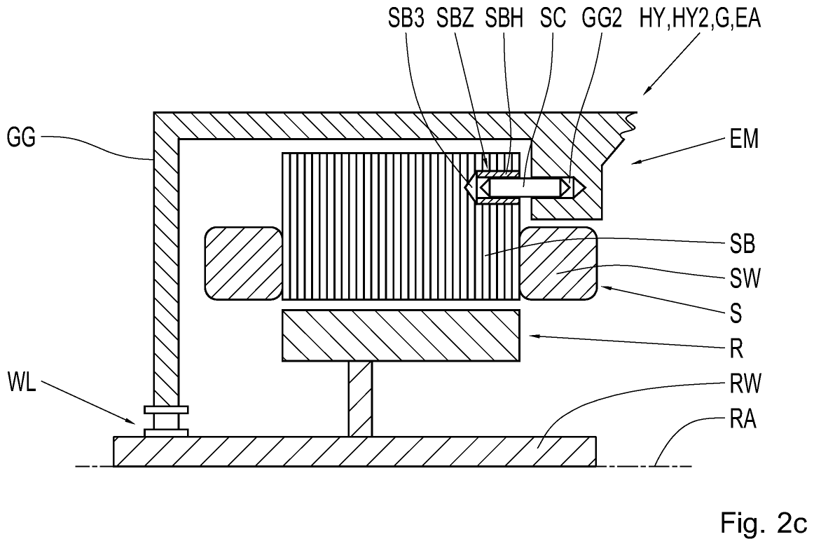

The hybrid modules HY, HY2, the hybrid transmission G, and the axle drive EA form drive units for the motor vehicle. FIG. 2a shows a schematic sectional view of a drive unit HY, HY2, G, EA of this type. The electric machine EM is arranged in a metallic housing GG and includes a rotationally fixed stator S and a rotor R. The rotor R is connected to a rotor shaft RW, which is mounted at the housing GG via a bearing WL. In this way, the rotor R, including the rotor shaft RW, can rotate about an axis RA.

The stator S includes a stator laminated core SB, at which at least one stator winding SW is arranged. The stator laminated core SB is secured at the housing GG via multiple screws SS, for example, via three screws SS. For this purpose, the stator laminated core SB has passage openings SB1, through which the screws SS are guided in the axial direction. Threaded holes GG1 are arranged in the housing GG, the threaded holes GG1 interacting with an external thread of the screws SS.

The stator S is electrically insulated from the housing GG in order to reduce the transmission of interference currents starting from the stator S via the housing GG and via the bearing WL to the rotor shaft RW. For this purpose, electrically insulating spacers SD are arranged between the stator laminated core SB and the housing GG. These spacers SD are made, for example, of ceramic or a high-pressure resistant plastic. Electrically insulating spacers SD2 are also arranged between a screw head of the screws SS and the stator laminated core SB.

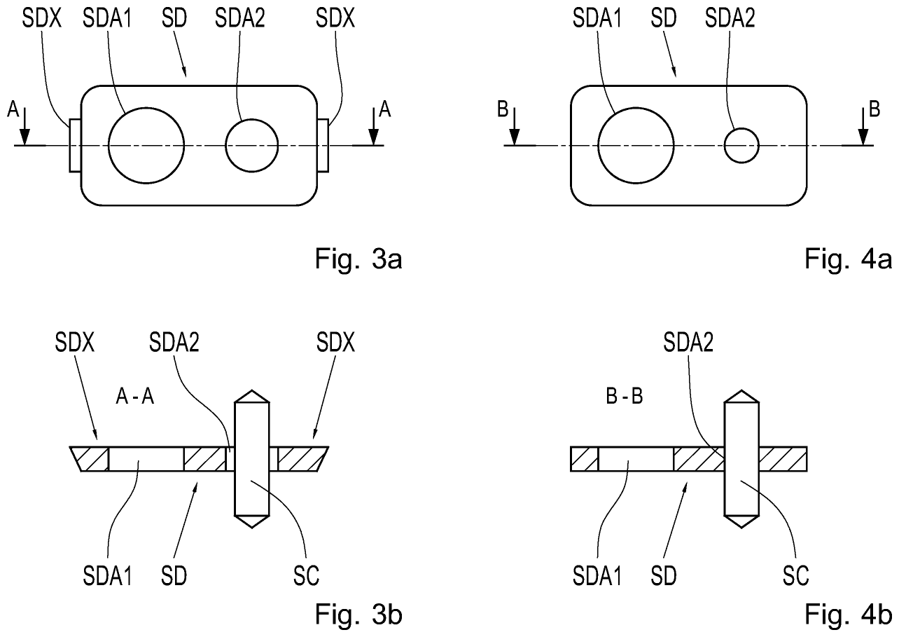

FIG. 2b shows another schematic sectional view of the drive unit HY, HY2, G, EA. FIG. 2b shows the centering of the stator S in the housing GG. Two centering pins SC are provided for centering, only one of these two centering pins SC being shown in the representation according to FIG. 2b. One end of the centering pin SC is arranged in a bore GG2 in the housing GG and the other end of the centering pin SC is arranged in a centering receptacle SBZ in the stator laminated core SB. In this exemplary embodiment, the centering receptacle SBZ is formed by a recess SB2. The centering pins SC are made of an electrically insulating material, for example, of ceramic. The centering pins SC are fitted into the bores GG2 and into the recesses SB2. The bores GG2 and the centering receptacle SBZ have a low position tolerance with respect to the axis RA in order to ensure an air gap between the stator S and the rotor R that is as uniform as possible. In the exemplary embodiment according to FIG. 2b, the centering pin SC extends through the spacer SD. Various embodiments, which are described by way of example in FIG. 3a through FIG. 6b, are possible for this purpose.

FIG. 2c shows a schematic sectional view of the drive unit HY, HY2, G, EA according to another possible example embodiment. In this example embodiment, the centering pins SC are made of a metallic material, for example, of steel. The centering receptacle SBZ includes electrically insulating sleeves SBH for the electrical insulation between the centering pin SC and the stator laminated core SB, the electrically insulating sleeves SBH being inserted into one recess SB3 each of the stator laminated core SB. The axial distance between the stator laminated core SB and the housing GG is ensured by the spacers SD, which are not visible in the sectional view according to FIG. 2c.

FIG. 3a shows a top view of a spacer SD according to a first exemplary embodiment. The spacer SD is plate-shaped and has a through-hole SDA1 and a through-hole SDA2. In the installed condition, one of the screws SS extends through the through-hole SDA1. The through-hole SDA1 is larger than the diameter of the screws SS. Projections SDX are formed at two opposite edges of the spacer SD. The projections SDX are used for holding the spacer SD in the housing GG, so that the spacer SD remains securely in position during assembly before the stator laminated core SB is secured at the housing GG. Via the projections SDX, the spacer SD can be clipped into appropriate receptacles in the housing GG.

FIG. 3b shows a sectional view through the spacer SD through a cutting plane A-A indicated in FIG. 3a, the centering pin SC being additionally shown. The centering pin SC extends through the through-hole SDA2, the diameter of the centering pin SC being smaller than the through-hole SDA2. This is the case because the spacer SD is held in position by the projections SDX, and so an appropriate position compensation with respect to the position of the centering pin SC is necessary.

FIG. 4a shows a top view of a spacer SD according to a second exemplary embodiment. FIG. 4b shows a sectional view through the spacer SD through a cutting plane B-B indicated in FIG. 4a, the centering pin SC being additionally shown. In contrast to the exemplary embodiment according to FIG. 3a and FIG. 3b, the projections SDX are dispensed with. The through-hole SDA2 is smaller in this case, enabling the centering pin SC to be fitted into the through-hole SDA2. In this type of design, the centering pins SC can be initially inserted into the bores GG2 of the housing GG during assembly. Thereafter, the spacers SD are slid onto the centering pins SC and held in position by the centering pins SC.

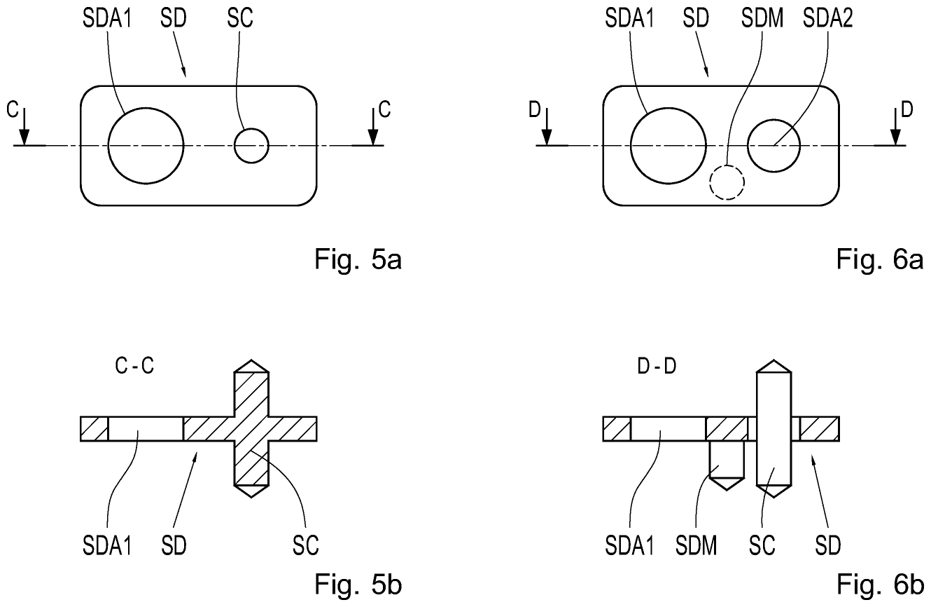

FIG. 5a shows a top view of a spacer SC according to a third exemplary embodiment. FIG. 5b shows a sectional view through the spacer SD through a cutting plane C-C indicated in FIG. 5a. The spacer SD according to the third exemplary embodiment is formed as one piece with the centering pin SC and, therefore, the through-hole SDA2 is dispensed with. This type of spacer SD that includes the centering pin SC can be realized, for example, by a ceramic component.

FIG. 6a shows a top view of a spacer SD according to a fourth exemplary embodiment. FIG. 6b shows a sectional view through the spacer SD through a cutting plane D-D indicated in FIG. 6a. The spacer SD includes a mounting pin SDM in this case. The mounting pin SDM is arranged on the housing-side end face of the spacer SD. In the assembled condition, the mounting pin SDM has been inserted into an appropriate receiving bore in the housing GG to hold the spacer SD in position. As a result, the projections SDX can be dispensed with. An embodiment of the spacer SD including two mounting pins SDM is also conceivable to prevent the spacer SD from tilting.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

VM internal combustion engine
HY hybrid module
HY2 hybrid module
G transmission
EA electric axle drive
AG differential gear
DW driving wheel
EM electric machine
S stator
SB stator laminated core
SB1 passage opening
SBZ centering receptacle
SB2 recess
SB3 recess
SW stator winding
R rotor
RW rotor shaft
RA axis of rotation
WL bearing
GG housing
GG1 threaded hole
GG2 bore
SS screw
SC centering pin
SD2 spacer
SD spacer
SDA1 through-hole
SDA2 through-hole
SDX projection
SDM mounting pin

1-14: (canceled)

15. An electric machine (EM) arranged within a housing (GG), the electric machine comprising:
a rotatably mounted rotor (R);
a rotationally fixed stator (S) electrically insulated with respect to the housing (GG), the stator (S) comprising a stator laminated core (SB) and at least one stator winding (SW) arranged at the stator laminated core (SB), the stator laminated core (SB) secured at the housing (GG) via a plurality of screws (SS) aligned in an axial direction;
a plurality of electrically insulating spacers (SD) arranged between the stator laminated core (SB) and the housing (GG); and
at least two centering pins (SC) configured for centering the stator (S) in the housing (GG).

16. The electric machine (EM) of claim 15, wherein each of the centering pins (SC) is arranged:
in a respective bore (GG2) in the housing (GG) at one end of each of the centering pins (SC); and
in a respective centering receptacle (SBZ) in the stator laminated core (SB) at another end of each of the centering pins (SC).

17. The electric machine (EM) of claim 16, wherein the centering pins (SC) are metallic and an electrical insulation is formed between the centering pins (SC) and the stator laminated core (SB) by the respective centering receptacle (SBZ).

18. The electric machine (EM) of claim 17, wherein the respective centering receptacle (SBZ) comprises an electrically insulating sleeve (SBH) inserted into a respective recess (SB3) in the stator laminated core (SB).

19. The electric machine (EM) of claim 15, wherein the centering pins (SC) are made of an electrically insulating material.

20. The electric machine (EM) of claim 15, wherein at least one of the plurality of spacers (SD) has a through-hole (SDA2), and at least one of the centering pins (SC) is guided through the through-hole (SDA2).

21. The electric machine (EM) of claim 15, wherein at least one of the plurality of spacers (SD) is held in position by at least one of the centering pins (SC).

22. The electric machine (EM) of claim 15, wherein at least one of the spacers (SD) is clipped into the housing (GG).

23. The electric machine (EM) of claim 15, wherein at least one of the centering pins (SC) is integrally formed as one-piece of seamless material with at least one of the spacers (SD).

24. The electric machine (EM) of claim 15, wherein a mounting pin (SDM) is formed with at least one of the spacers (SD), the mounting pin (SDM) engaged with a receiving bore in the housing (GG).

25. The electric machine (EM) of claim 15, wherein at least one of the spacers (SD) is bonded onto the stator laminated core (SB) or onto the housing (GG).

26. The electric machine (EM) of claim 15, wherein an air gap is defined between the screws (SS) and the spacers (SD).

27. The electric machine (EM) of claim 26, wherein each of the screws (SS) is guided through a respective through-hole (SDA1) of the spacers (SD).

28. A drive unit (HY, HY2, G, EA) for a motor vehicle, comprising:
the electric machine (EM) of claim 15, wherein the electric machine (EM) is configured for driving the motor vehicle.
